(19) United States
(12) Patent Application Publication
(10) Pub. No.: US 2007/0012605 A1
(43) Pub. Date: Jan. 18, 2007

(54) Self-propelled Apparatus for Cleaning A Water Treatment Tank

(76) Inventor: Caroline Vergara Chiang, Diamond Bar, CA (US)

Correspondence Address: CAROLINE VERGARA CHIANG, 1632 KIOWA CREST DRIVE, DIAMOND BAR, CA, 91765, US

(21) Appl. No.: 11/160,947

(22) Filed: Jul. 15, 2005

(51) Int. Cl. B01D 21/24

(52) U.S. Cl. 210/97; 210/523

(57) ABSTRACT

An apparatus for retarding algae growth from the baffle, weir, spillway and clean water channel members of a waste water treatment tank comprised of a guided, motor-driven carriage with a pump mounted on the motorized carriage whose suction utilizes water from the cleaned effluent channel, or alternate source, and directs it through a fluid conduit having a plurality of spray nozzles positioned to direct the pressurized cleaned effluent onto the baffle, weir, spillway, and clean water channel members of a waste water treatment tank.

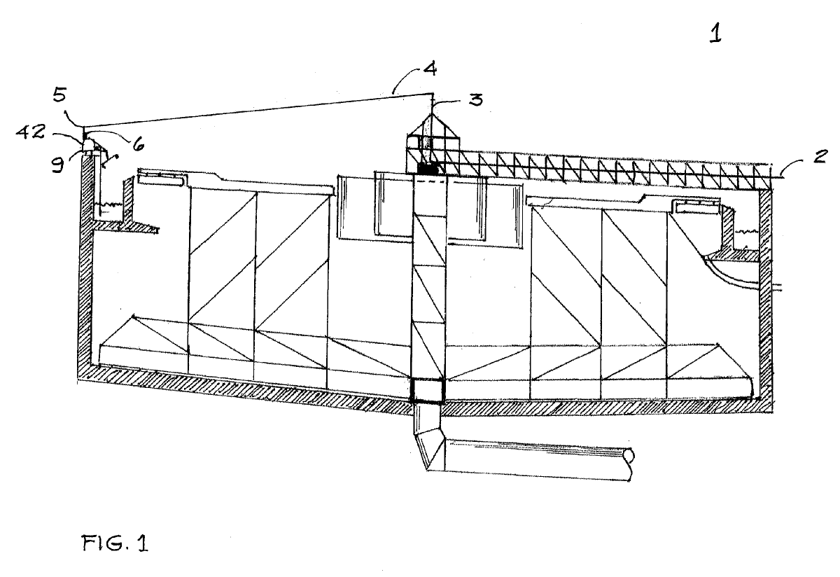

FIG. 1 is a plan view of a sewage waste water clarification system embodying the cleaning apparatus of the present invention;

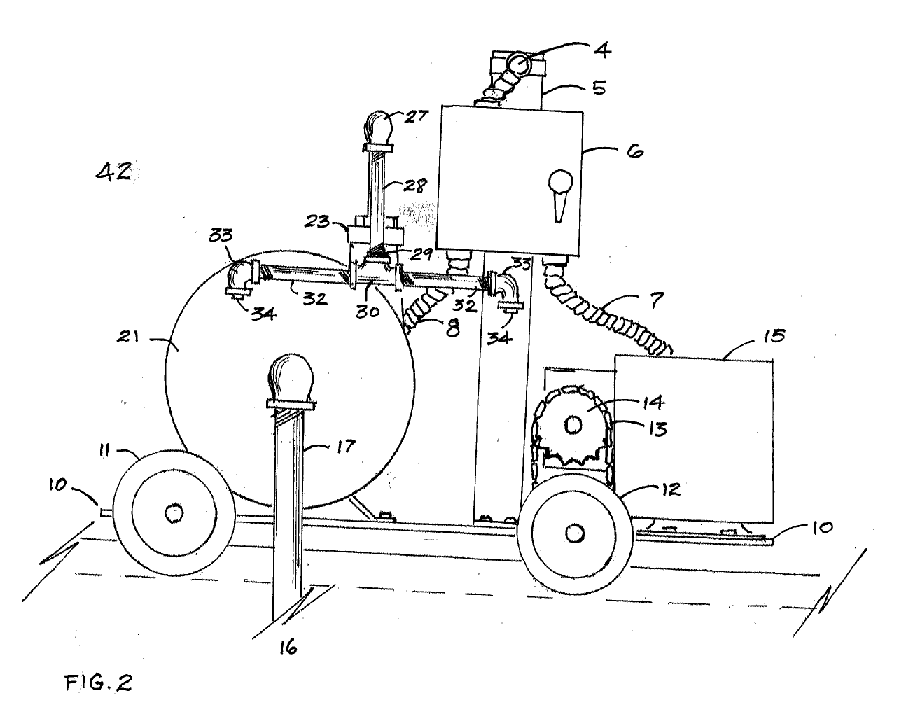

FIG. 2 is a lateral perspective view of a detail of the cleaning apparatus of the present invention;

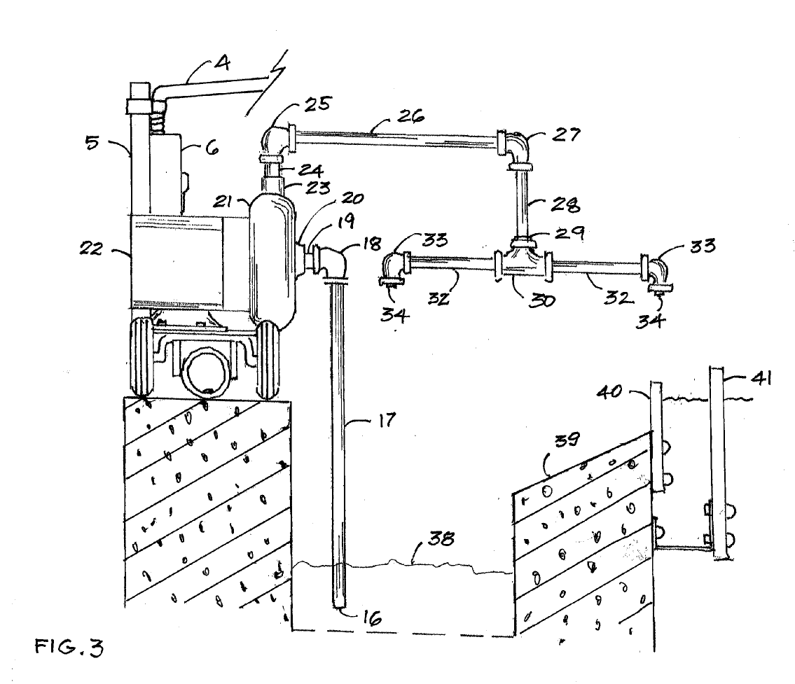

FIG. 3 is a frontal perspective view of the same cleaning apparatus of the present invention; and,

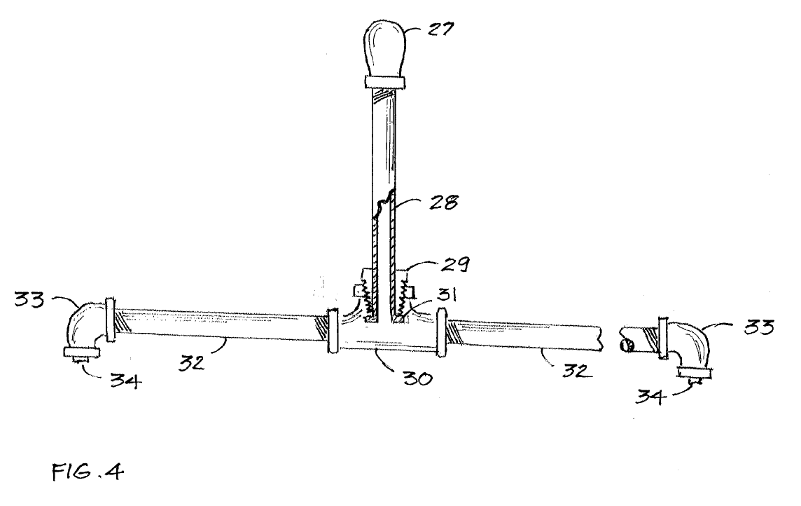

FIG. 4 is a detailed view of the fluid conduit and spray nozzles.

FIG. 1 depicts a waste water treatment tank 1 which illustrates an insulated power source 2 which runs along the service walkway and is elevated to a convenient level by a frame structure 3 at the center of the entire treatment tank which acts as a pivot for the power line 4 connected to the rigid post 5 into a power distribution panel 6 for the motors and sensors mounted on platform 9 of the apparatus of the present invention 42 while in motion. It should be noted that there are such alternate power sources such as solar, battery and water powered motors that may also be utilized with the present invention.

FIG. 2 is a lateral perspective view showing a power line 4 secured and supported by a rigid post 5 and is wired internally inside a power distribution panel 6 which supplies power to the motor via a water proof insulated cable 7 to gear motor 15, water proof insulated cable 8 to the pump motor 22 (not illustrated due to location behind pump volute 21,) and sensors 10 mounted and powered within the power distribution panel (it should be noted that switches may be used in place of sensors as a means of reversing the rotation of the motor.) Illustrated is a first set of wheels 11 shown as non-driven wheels optionally, a second set of wheels 12 containing receiving sprocket (not shown) driven by a gear motor 15 linked to the wheel by sprocket 14, and chain 13. Sprocket 14 is mounted and activated by the driveshaft of the gear motor 15. The gear motor 15 in turn activates the sprocket, which moves the chain 13 which contacts and activates the wheel set 12 to drive the apparatus 42. It should be noted that a switch 10 may be mounted on either end of the apparatus to change the direction of the gear motor rotation, thereby changing the direction of the rotation of the wheels permitting automatic and constant operation along the perimeter of the treatment tank.

FIG. 3 shows a suction conduit 17 connected to an elbow 18 to a nipple 19, which is connected to the suction of the pump 20 whose suction is created by the impeller inside the volute 21 driven by the motor 22. The pressurized water then travels to the pump discharge 23 through the nipple 24, to an elbow 25, to a nipple 26, to an elbow 27.

FIG. 4 shows in greater detail elbow 27 connected to a nipple 28, to a bushing 29, made of a softer material, which acts as a center of rotation between nipple 28 and tee joint 30, allowing tee joint 30 and connections to rotate freely. Tee joint 30 is connected to nipple 32, which is connected to an elbow 33 which has in it a nozzle 34 which creates a jet for cleaning and provides force which rotates tee joint 30. It should be noted that elbow 33 can be adjusted to a proper opposing angle to encourage movement of tee joint 30. Within tee joint 30 is contained sealing ring 31 which is threaded into nipple 28 acting as a seal for prevention of water leakage against bushing 29. It should also be noted that the simplicity of the construction of the conduit and nozzle system facilitates ease in repair.

Referring to FIG. 3 the water source for the inlet 16 of the suction conduit 17 is the clean effluent channel 38 produced by clean water run off from weir 40 that runs down the spillway 39 into the clean effluent channel 38 which regularly contains a consistent level of clean effluent available as a water supply to the apparatus. The jet created by nozzle 34 and rotated by tee joint 30 of the aforementioned system is directed to the baffle 41, weir 40, spillway 39 and clean effluent channel 38. It should be recognized that the arrangement and quantity of the conduits and nozzles may vary to accommodate various makes and models of water treatment tanks. The resulting force of water created by the conduit and nozzle system prevents algae and particulate buildup on the baffle 41, weir 40, spillway 39 and clean effluent channel 38 which eliminates the task of removing the growth by menial tasks, such as hosing down and scrubbing the surfaces for removal usually done with brushes. The automatic reversing feature of the motor assures consistent operation with a minimum of maintenance. It should be noted that alternate water sources can also be utilized to provide water to the jet system should the need arise. A track 36, constructed of a flexible conduit, fastened to and running in line with the outer tank wall 37 contacts the guides 35 positioned beneath the apparatus platform 9, which aids in maintaining a desirable path in which the apparatus can optimally perform its task.

### TECHNICAL FIELD

The present invention relates generally to the cleaning of sewage water facilities and more particularly, to a self-propelled apparatus for inhibiting the growth of algae from the surfaces of a final sedimentation sewage treatment tank.

### BACKGROUND OF THE INVENTION

In a typical water treatment facility, raw sewage is passed through a series of screens and sedimentation tanks that remove the larger waste solids and particulates. In the final settling stages the removal of clarified effluent is generally accomplished by means of an annular trough formed by weirs which permit the clarified liquid to spill into the trough from which it is removed by pipes or conduits to the final clarification processes. As commonly known in the art, the outdoor exposure of the sewage water treatment tanks in direct sunlight encourages the growth of algae, most prevalent on the baffle, weir, spillway and clean water channel. Algae growth on these members inhibits the flow of clean water effluent from the tank. Further, the algae can be dislodged by currents and carried in concentrated masses in the clean water being discharged from the tank. These large concentrations of algae impede the effectiveness of the filtering systems and often cause necessary, labor intensive and costly interruptions in order to free the related drains, conduits or filters of algae.

Although it is impossible to prevent the formation of algae, it is highly desirable that the growth be controlled to minimize the frequency of interruptions to the process. The most common methods of cleaning the algae and debris from the waste water treatment tank have utilized the use of brushes manually or mechanically. It is obvious the amount of labor to do this manually is time consuming and therefore, costly.

As presented in U.S. Pat. Nos. 5,720,890 of Caliva, U.S. Pat. No. 4,876,010 of Riddle, and U.S. Pat. No. 4,830,748 of Hall, the main component of their designs are various brushes. While the apparatuses and methods function adequately, all of these designs specify that the brush components of their invention be mounted to the rotating skimmer arm of the tank. As commonly known in the art, not all tanks have rotating skimmer arms, identifying a need for an invention to clean tanks without skimmer arms. U.S. Pat. No. 4,978,447 of Hall, has addressed this issue by creating a self-propelled apparatus whose track is mounted on the inner periphery of the outer wall of the tank's clean water channel. This process involves many complex components and the same result can be achieved in a more practical and efficient fashion. U.S. Pat. No. 6,016,924, Caliva has updated his spring-loaded brush arms by enabling them to pivot about a vertical axis and a horizontal axis to compensate for an out of round sewage water treatment tank. While it may be effective, the primary component of this invention is also a series of brushes.

The use of brushes that contact the water treatment tank, as all previous inventions have in common, all have the disadvantage of requiring cessation of the water treatment process to maintenance or repair the apparatus. The present invention accomplishes the task of cleaning the water treatment tank while eliminating interruptions in the water treatment processes.

### SUMMARY OF THE INVENTION

The present invention is directed to an apparatus and method of controlling the growth of algae on surfaces of a sewage water clarification tank.

It is therefore an objective of this invention to provide a cleaning apparatus which is easy to install and incorporate with existing waste water treatment tanks circular or not.

It is another object of this invention to provide a cleaning apparatus which will automatically clean and prevent algal buildup from hindering the waste water treatment process and will do so by utilizing an existing water source.

By utilizing the clean water effluent channel, or other on site means, of the sewage water treatment tank itself, an effective and efficient water jet system is directed to the baffle, weir, spillway and clean water effluent channel loosening algae and debris, inhibiting the algal tendency to clump together in masses. The resulting effluent contains particles that are easily handled by the remaining filtering processes.

By utilizing the outer wall of the waste water tank with a track, a reliable path for cleaning is created. The outer wall itself may also serve as a track should it be more efficient to do so. The simple and durable motor mechanism allows for low maintenance and ease of operation. The reversing switches or sensors mounted on each end allow automated operation. The simplicity of the components of the apparatus: the motor, the pump and the nozzles, are contained within the apparatus and do not impede the waste water cleaning process, nor does it require shut down or drainage of the waste water cleaning tank to maintain or repair any components of the apparatus. Both the apparatus and its simple components amount to time and money saved to the operator and the water plant.

Other objects and advantages of the present invention will become apparent to those skilled in the art from the following description wherein there is shown and described a preferred embodiment of this invention. As it will be realized, the invention is capable of many embodiments and its several details are capable of modifications in various, obvious aspects without departing from the invention. Accordingly, the drawings and descriptions will be regarded as illustrative in nature and not restrictive.

What is claimed is:

1. An apparatus for cleaning algae and other debris from most commonly a circular, but not limited to a circular tank only, water treatment tank including an influent source, a service walkway, a peripheral baffle having inside and outside surfaces, a weir, a spillway and a clean water flow channel comprising:
a carriage means;
means mounted on said carriage:
means for driving said carriage in a path of movement about the periphery of said treatment tank;
means for guiding said carriage as it is driven;
means of reversing the direction of travel of said carriage;
means utilizing available water from a source through a pump directing the water through a fluid conduit or conduits with a plurality of spray nozzles positioned to direct water onto the baffle, weir, spillway and clean water flow channel to inhibit the growth of algae and debris buildup;
means of inhibiting the build up of algae and debris on the baffle, weir, spillway and clean water flow channel of a waste water treatment tank by an apparatus whose independent operation and maintenance does not relate to, require or interrupt the water treatment process.
